(19) United States
(12) Patent Application Publication
(10) Pub. No.: US 2010/0077999 A1
(43) Pub. Date: Apr. 1, 2010

(54) INTERNAL COMBUSTION ENGINE

(76) Inventor: Naoya Okada, Kasugai-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/594,071

(22) PCT Filed: Apr. 8, 2008
(86) PCT No.: PCT/JP2008/056935

§ 371 Date: Sep. 30, 2009

(30) Foreign Application Priority Data
Apr. 18, 2007 (JP) 2007-109282

(51) Int. Cl. F02B 25/06

(52) U.S. Cl. 123/572

(57) ABSTRACT

An internal combustion engine 10 in which a blow-by gas processing apparatus is provided. Communication passages 24A and B for communicating interiors of cylinder heads 17A and 17B and an interior of a crankcase 12 are formed in the banks VA and VB, respectively. The blow-by gas processing apparatus includes a fresh air introduction passage 27 for communicating the interior of the cylinder head 17A and an intake passage 25 of the engine 10, and a breather passage 29 for communicating an interior of the cylinder head 17B and the intake passage 25. A partition wall 31 for partitioning between the breather passage 29 and the fresh air introduction passage 27 and also between the communication portion of the communication passage 24A in the cylinder head 17A and the communication portion of the communication passage 24B in the cylinder head 17B is provided in a passageway including the interiors of the cylinder heads 17A and 17B, the interior of a chain cover 23, the fresh air introduction passage 27, and the breather passage 29. The partition wall 31 has a through-hole 32. Thus, blow-by gas in the engine 10 can be processed as appropriate.

### TECHNICAL FIELD

The present invention relate to an internal combustion engine provided with a blow-by gas processing apparatus, wherein the engine includes two banks.

### BACKGROUND ART

As an apparatus applied to an internal combustion engine such as an engine of a vehicle, a blow-by gas processing apparatus is known. This blow-by gas processing apparatus processes combustion gas or blow-by gas so that blow-by gas that is leaked from a gap between an inner wall surface of a cylinder bore and a piston is ventilated into a crankcase, and the ventilated blow-by gas is returned to intake air. In the blow-by gas processing apparatus, blow-by gas in the engine is generally sucked into an intake passage by suction negative pressure occurred at the portion downstream of a throttle valve in the flowing direction of intake gas (referred to as “downstream side” hereinafter) to be returned to intake air. In an internal combustion engine having such a blow-by gas processing apparatus, the amount of hydrocarbon (HC) discharged into the air can be reduced since the blow-by gas returned into the intake gas is burned again in a combustion chamber. Also, ventilation in the engine can prevent degradation of oil by blow-by gas.

The above blow-by gas processing apparatus is also applicable to an internal combustion engine having two banks, such as an engine having V-cylinder arrangement. An example of such engine is described in Patent Document 1.

In the internal combustion engine of the Patent Document 1, a communication passage for connecting an interior of a cylinder head and an interior of a crankcase is provided in each of two banks, i.e., a first bank and a second bank. The interior of the cylinder head of the first bank is connected to the intake passage on the upstream side of the throttle valve while the interior of the cylinder head of the second bank is connected to the intake passage on the downstream side of the throttle valve.

In this engine, the pressure difference generated between the upstream side of the intake passage and the downstream side of the intake passage causes air that is located upstream of the throttle valve of the intake passage to flow through the cylinder head of the first bank into the crankcase, and causes blow-by gas in the crankcase to be discharged downstream of the throttle valve of the intake passage through the cylinder head of the second bank. In this way, blow-by gas in the engine is processed.

Meanwhile, an internal combustion engine is provided with a winding mechanism for operatively coupling a crank shaft and cam shafts. As such a winding mechanism, a chain mechanism is used frequently. Moreover, a chain cover is attached to the engine having a chain mechanism to prevent oil supplied to the chain for lubrication from splashing out of the engine.

Usually, a chain cover that is configured to cover the entire outward of the engine is attached to the outer wall of the engine. The interior of the chain cover is connected to the interior of the cylinder head of each bank. Thus, the engine is configured so that the interiors of cylinder heads are connected each other via the chain cover. In this regard, in the blow-by gas processing apparatus applied to such engine, a part of air, that flows from the portion of the intake passage that is on the upstream side of the throttle valve into one cylinder head, adversely flows through the chain cover, the other cylinder head, and out to the portion of the intake passage that is on the downstream side of the throttle valve, without passing through the crankcase.

As stated previously, blow-by gas is gas leaked into the crankcase from the combustion chamber of the engine. Thus, a large amount of blow-by gas exists in the crankcase. As the amount of air bypassing the crankcase becomes excessive, this may decrease in processing efficiency of blow-by gas.

### Patent Document 1: Japanese Laid-open Utility Model Publication No. 2-139315

### SUMMARY OF THE INVENTION

An objective of the invention is to provide an internal combustion engine capable of processing blow-by gas in the engine appropriately.

The present invention provides an internal combustion engine provided with a blow-by gas processing apparatus. The engine includes a cylinder head, a crankcase, a crank shaft in the crankcase, an intake passage in which a throttle valve is provided, two banks, i.e., a first bank and a second bank, a communication passage for communicating an interior of the cylinder head and an interior of the crankcase with an interior of each bank, a cam shaft, a chain mechanism for operatively couple the crank shaft and each cam shaft, and a chain cover configured to cover the chain mechanism outward the engine; wherein an interior of the chain cover is connected to an interior of each cylinder head, wherein the blow-by gas processing apparatus includes a fresh air introduction passage for communicating an interior of the cylinder head provided at the first bank and a part of the intake passage on the upstream side of the throttle valve in the flowing direction of intake air and a breather passage for communicating an interior of the cylinder head provided at the second bank and a part of the intake passage on the downstream side of the throttle valve in the flowing direction of intake air. The internal combustion engine further includes a partition wall, wherein the partition wall is located in a passageway including the interior of each cylinder head, the interior of the chain cover, the fresh air introduction passage, and the breather passage. The partition wall partitions the breather passage and the fresh air introduction passage. The partition wall partitions a communication portion of the communication passage in the cylinder head provided at the first bank and a communication portion of the communication passage in the cylinder head provided at the second bank. The partition wall includes a through-hole.

In one aspect, an interior of the crankcase and an interior of the chain cover communicate each other, and the partition wall and the through-hole are disposed closer to the fresh air introduction passage than the communication portion between the interior of the crankcase and the interior of the chain cover in the passageway.

In another aspect, the partition wall and the through-hole are provided in the interior of the cylinder head provided at the first bank.

In yet another aspect, the communication passage is a passage that allows gas communication between the interior of the cylinder head and the interior of the crankcase and that causes oil to flow from the interior of the cylinder head down to the interior of the crankcase. The cross-sectional area of the through-hole is from one-third (⅓) to one-second (½) of the cross-sectional area of the communication passage formed at the first bank.

### BRIEF DESCRIPTION OF DRAWINGS

FIG. 1 is a schematic diagram illustrating a general configuration of an embodiment of an internal combustion engine according to the invention;

FIG. 2 is a side view illustrating a side structure of the engine of FIG. 1;

FIG. 3 is a plan view illustrating a structure of a first bank of the engine of FIG. 1, viewed from a cylinder head cover;

FIG. 4 is a side view illustrating a side structure of the first bank, viewed from the direction indicated by arrow C of FIG. 3;

FIG. 5 is a cross-sectional view illustrating a cross-sectional structure of the first bank, taken along the line D-D of FIG. 3;

FIG. 6 is a schematic diagram illustrating gas flows within the first bank;

FIG. 7 is a schematic diagram illustrating gas flows within a second bank of the engine; and

FIG. 8 is a graph representing the relationship between a ratio of a cross-sectional area of a through-hole to a sum of cross-sectional areas of a plurality of communication passages, and concentration of blow-by gas in the engine.

### BEST MODE FOR CARRYING OUT THE INVENTION

An embodiment of an internal combustion engine according to the invention is described.

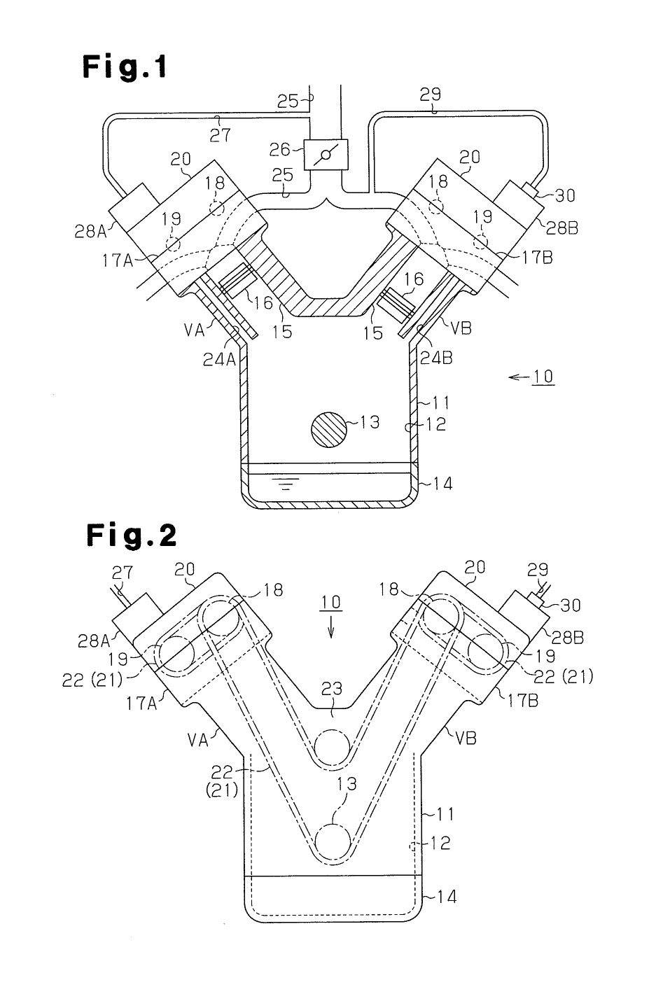

FIG. 1 illustrates a general configuration of the embodiment of the engine. As illustrated in FIG. 1, an internal combustion engine 10 is an internal combustion engine having V-shaped arrangement of cylinders.

The engine 10 includes a cylinder block 11. A lower part of the cylinder block 11 constitutes an upper part of an crankcase 12. A crank shaft 13 is rotatably attached to the interior of the crankcase 12. An oil pan 14 is attached to the lower part of the cylinder block 11. The oil pan 14 constitutes a lower part of the crankcase 12. The oil pan 14 stores oil to be supplied to each sliding portion of the engine 10.

A plurality of cylinder bores 15 are formed at the upper part of the cylinder block 11, i.e., at the lower part of a first bank VA and the lower part of a second bank VB of the engine 10. A piston 16 is provided in each cylinder bore 15 to reciprocatively move in the cylinder bore 15. In this embodiment, the number of the cylinder bores 15 is a total of six, in which each of the first bank VA and the second bank VA VB makes three. In FIG. 1, only one bore is illustrated for each of the first bank VA and the second bank VB.

Two cylinder heads 17A, 17B are attached to the upper part of the cylinder block 11. One cylinder head 17A constitutes an upper part of the first bank VA while the other cylinder head 17B constitutes an upper part of the second bank VB. An intake cam shaft 18 and an exhaust cam shaft 19 are rotatably attached to the each of interior of the cylinder head 17A and the interior of the cylinder head 17B. A cylinder head cover 20 is attached to the upper part of each cylinder head 17A and 17B. The cylinder head covers 20 cover the cylinder heads 17A and 17B at the location outward of the engine 10 so as to prevent oil within the cylinder heads 17A and 17B (specifically, oil to be used for lubricating a member such as a bearing of a cam shaft) from leaking out of the engine as well as to prevent the interior of the cylinder heads 17A and 17B from being exposed to outside the engine

FIG. 2 illustrates a side structure of the engine 10.

As illustrated in FIG. 2, a chain mechanism 21 is attached to the engine 10. The chain mechanism 21 includes chains 22 wound around the intake cam shafts 18 and the exhaust cam shafts 19 of the banks VA and VB and the crank shaft 13. In particular, the chains 22 include a primary chain 22 wound on the intake cam shafts 18 of the banks VA and VB and the crank shaft 13, and a secondary chains 22 wound on the intake cam shaft 18 and the exhaust cam shaft 19 in each bank VA, VB. The chain mechanism 21 conveys the rotational force exerted by the crank shaft 13 to the intake cam shaft 18 and the exhaust cam shaft 19 of each bank VA, VB thereby driving the intake cam shaft 18 and the exhaust cam shaft 19 to rotate.

A chain cover 23 is attached to the engine 10. This chain cover 23 covers the chain mechanism 21 outward the engine 10 so as to prevent oil to be supplied to portions of the chain mechanism 21 that are to be lubricated from leaking out of the engine as well as to prevent the chain mechanism 21 from being exposed to outside the engine.

The chain cover 23 is configured to have upper portions that are open when the chain cover 23 is attached to the engine 10. The cylinder head covers 20 are attached to the engine 10 to cover the opened upper portions of the chain cover 23. Thus, in the engine 10, the interior of the chain cover 23 and the interior of the cylinder head covers 20 of the banks VA and VB communicate, and even the interior of the chain cover 23 and the interior of the cylinder heads 17A and 17B communicate.

The chain cover 23 is also configured to have a lower portion that is open when the chain cover 23 is attached to the engine 10. The oil pan 14 is attached to the engine 10 to cover the opened lower portion of the chain cover 23. Thus, in the engine 10, the interior of the chain cover 23 and the interior of the oil pan 14 are communicated to allow the oil after use for lubricating the chain mechanism 21 to fall down into the oil pan 14. In the engine 10, the interior of the chain cover 23 and the interior of the crankcase 12 are also communicated.

A blow-by gas processing apparatus for processing combustion gas, or blow-by gas, leaked from a gap between an inner wall surface of each cylinder bore 15 (FIG. 1) and the corresponding piston 16 is provided in the engine 10. The blow-by gas processing apparatus will be explained in detail below.

A plurality of communication passages 24A are formed in the first bank VA of the engine 10 to communicate the interior of the cylinder head 17A and the interior of the crankcase 12. A plurality of communication passages 24B are formed in the second bank VB to communicated the interior of the cylinder head 17B and the crankcase 12. The communication passages 24A are used as passages to send the air from the cylinder head 17A to the crankcase 12. The communication passages 24B are used as passages to expel blow-by gas from the crankcase 12 to the cylinder head 17B. The communication passages 24A, 24B are also used as passages to return oil in the cylinder heads 17A, 17B to the oil pan 14.

A fresh air introduction passage 27 is provided in the engine 10 to communicate the interior of the cylinder head 17A of the first bank VA with the intake passage 25 at the portion upstream of the throttle valve 26 in the flowing direction of intake air (referred to as “upstream side” hereinafter). An oil separator 28A is attached to the cylinder head cover 20 of the first bank VA. An end of the fresh air introduction passage 27 on the side of the engine 10 is connected to the oil separator 28A. The oil separator 28A separates oil components from gas that passes through the separator 28A. The oil separator 28A prevents oil from intruding from the interior of the cylinder head 17A into the fresh air introduction passage 27.

A breather passage 29 is also provided in the engine 10 to communicate the interior of the second bank VB with the intake passage 25 at the portion downstream of the throttle valve 26 in the flowing direction of intake air (referred to as “downstream side” hereinafter). An oil separator 28B and a PCV valve 30 are attached to cylinder head cover 20 of the second bank VB. An end of the breather passage 29 on the side of the engine 10 is connected to the oil separator 28B through the PCV valve 30. The PCV valve 30 is a pressure difference valve the opening degree of which varies depending on the difference between the pressure in the cylinder head 17B and the pressure in the intake passage 25. The PCV valve 30 self-adjusts flow rate of blow-by gas (more exactly, gas including blow-by gas) that is discharged to the intake passage 25 via the breather passage 29 based on the difference in pressures. The oil separator 28B separates oil components from gas that passes through the separator 28B. The oil separator 28B allows the gas after the oil components are separated to be discharged from the interior of the cylinder head 17B to the breather passage 29.

In the internal combustion engine 10 provided with such a blow-by gas processing apparatus, air flows in a following manner, depending on the pressure difference generated between the upstream side and the downstream side of the throttle valve 26 in the intake passage 25. Specifically, air that is located on the upstream side of the throttle valve 26 in the intake passage 25 flows in a basic passageway including the fresh air introduction passage 27, the cylinder head 17A, the communication passages 24A, the crankcase 12, the communication passages 24B, the cylinder head 17B, the breather passage 29, and the intake passage 25 (on the downstream side of throttle valve 26). Then, blow-by gas in the engine 10, together with air, is discharged into the intake passage 25. In the engine 10 of this embodiment, blow-by gas in the engine 10 is ventilated and processed by flowing air through the basic passageway.

As described above, the interior of each cylinder head 17A, 17B and the interior of the chain cover 23 communicate each other in the engine 10. Thus, air that is located on the upstream side of the throttle valve 26 in the intake passage 25 flows not only the basic passageway but also a bypass passageway including the fresh air introduction passage 27, the cylinder head 17A, the chain cover 23, the cylinder head 17B, the breather passage 29, and the intake passage 25 (on the downstream side of the throttle valve 26).

To ventilate blow-by gas in the engine 10 efficiently, it is desirable to reduce the amount of gas that flows through the chain cover 23 by bypassing the portion where large amount of blow-by gas generates (i.e., the interior of the crankcase 12) while to increase the amount of gas that flows through the interior of the crankcase 12. However, since blow-by gas also intrudes into the chain cover 23, a small amount of air is needed to be sent to the chain cover 23 to ventilate this blow-by gas.

In this regard, in the present embodiment, a partition wall and a through-hole are disposed in the bypass passageway. Disposition of the partition wall and the through-hole will be described in detail below.

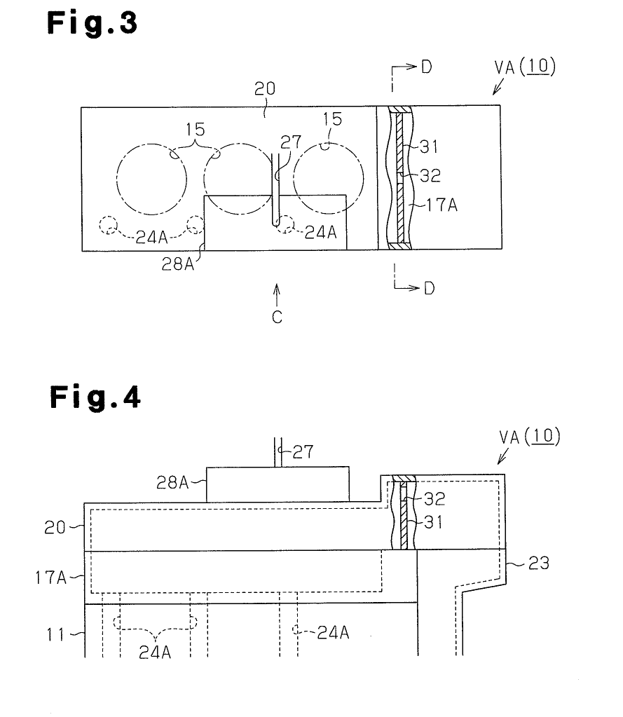

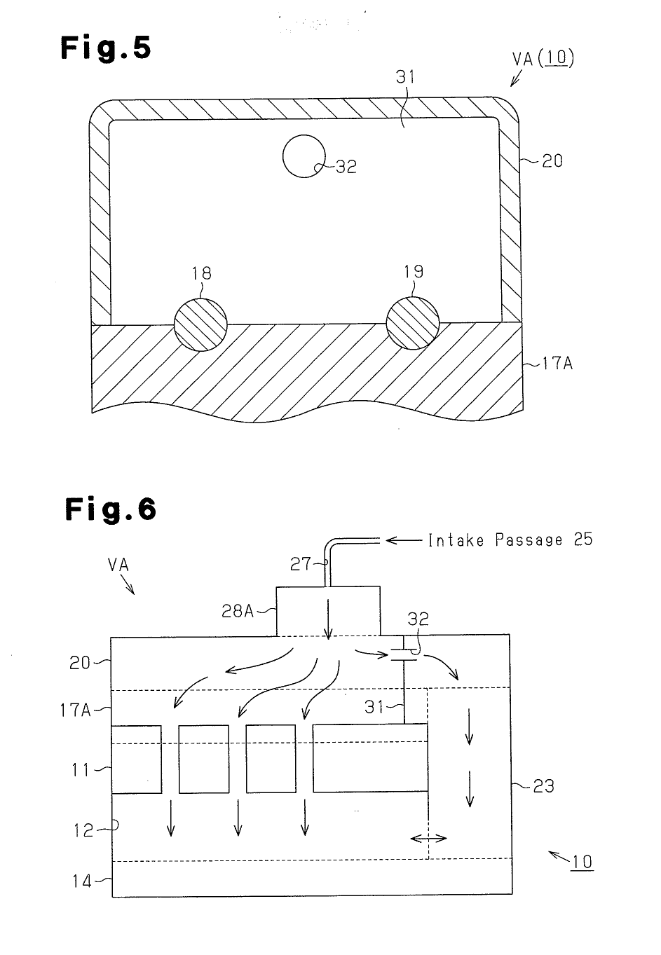

FIG. 3 is a structure of the first bank VA of the engine 10 of FIG. 1 viewed from the side of the cylinder head cover 20. FIG. 4 is the structure of the first bank VA viewed from the direction indicated by arrow C of FIG. 3. FIG. 5 is a cross-sectional structure of the first bank VA taken along the line D-D of FIG. 3.

As illustrated in FIGS. 3 to 5, a partition wall 31 is attached to the cylinder head 17A of the engine 10. The partition wall 31 is configured to partition the interior of the cylinder head 17A (more specifically, the interior of the cylinder head 17A and the interior of the cylinder head cover 20) into two compartments. In particular, the partition wall 31 is configured to separate the communication passages 24A from the interior of the chain cover 23 and configured to separate the communication portion of the fresh air introduction passage 27 (i.e., the oil separator 28A) from the interior of the chain cover 23.

A through-hole 32 is formed in the partition wall 31. The cross-sectional area of the through-hole 32 is set to be from one-third (⅓) to one-second (½) of the sum of the cross-sectional areas of a plurality of the communication passages 24A formed in the first bank VA of the engine 10.

The operation brought by provision of the partition wall 31 and the through-hole 32 in the engine 10 will be explained below.

FIG. 6 illustrates gas flows within the first bank VA of the engine 10.

As indicated by the arrows in FIG. 6, during the operation of the engine 10, air in the intake passage 25 flows into the cylinder head 17A via the fresh air introduction passage 27 and the oil separator 28A. Air that flew into the cylinder head 17A then flows into the crankcase 12 through each communication passage 24A as well as flows into the chain cover 23 via the through-hole 32 of the partition wall 31.

Since the partition wall 31 and the through-hole 32 are provided, this embodiment allows less amount of air to flow into the chain cover 23 from the cylinder head 17A and more amount of air to flow into the crankcase 12, compared with the internal combustion engine having neither partition wall 31 nor through-hole 32. That is, large amount of air is sent into the crankcase 12 so as to ventilate blow-by gas in the crankcase 12 sufficiently while a small amount of air is also sent into the chain cover 23 so as to ventilate blow-by gas in the chain cover 23 appropriately. In this way, appropriate amounts of air are sent both into the crankcase 12 and into the chain cover 23.

In the operation of the engine 10, a large amount of oil is supplied to the chain mechanism 21 for lubrication thereof. Thus, if the partition wall and the through-hole are formed in the chain cover 23, the amount of oil flowing down through the chain cover 23 would be limited. This may cause degradation of lubrication performance of the chain mechanism 21 such as stagnation of oil in the chain cover 23. However, in this embodiment, the partition wall 31 and the through-hole 32 are formed in the cylinder head 17A with which the fresh air introduction passage 27 communicates. Thus, the partition wall 31 and the through-hole 32 can be disposed without degrading the lubrication performance.

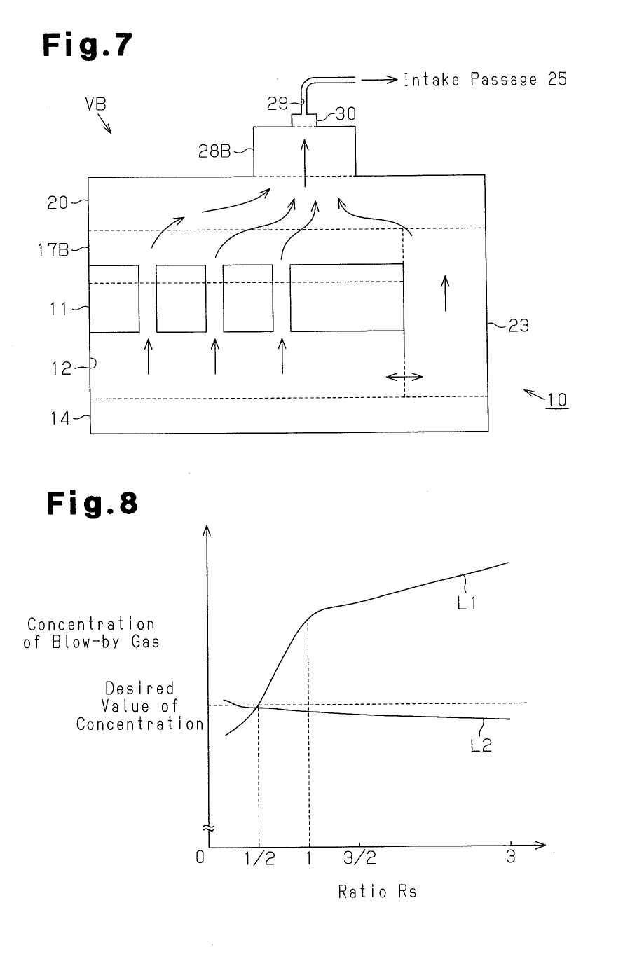

FIG. 7 illustrates gas flows within the second bank VB of the engine 10.

As illustrated by the arrows in FIG. 7, air that flew into the crankcase 12 and air that flew into the chain cover 23 flow into the cylinder head 17B through the communication passages 24B and the chain cover 23 of the second bank VB. Then, air that flew into the cylinder head 17B (more exactly, gas including blow-by gas) is discharged to the intake passage 25 through the PCV valve 30 and the breather passage 29. In this way, blow-by gas in the engine 10 is returned to the intake air and processed to be combusted again in the engine 10.

The inventor conducted various experiments and confirmed that, in the engine 10 according to the present embodiment, oil cannot be returned appropriately from the cylinder head 17A to the oil pan 14 (FIG. 1) when the cross-sectional area of the through-hole 32 (see FIGS. 3 to 5) is smaller than one-third (⅓) of the sum of cross-sectional areas formed in the first bank VA of the engine 10. The possible reason for this disadvantage is as follows.

During the operation of the engine 10, when the opening degree of the throttle valve 26 becomes greater and no pressure difference is generated between the downstream side of the throttle valve 26 and upstream side of the throttle valve 26 in the intake passage 25, air flow from the cylinder head 17A into the crankcase 12 is stopped. In this situation, the amount of blow-by gas in the crankcase 12 has already increased, so that gas including blow-by gas in the crankcase 12 flows back into the cylinder head 17A through the communication passages 24A and the chain cover 23. Of the total amount of the gas flowing back from the crankcase 12 to the cylinder head 17A, the proportion of the amount of gas passing through the communication passages 24A becomes larger as the cross-sectional area of the through-hole 32 is set smaller. In other words, the amount of gas that flows back becomes greater as the cross-sectional area of the through-hole 32 is smaller.

As described previously, oil flows from the cylinder head 17A down to the oil pan 14 through the communication passages 24A. Thus, if the amount of gas that flows back through the communication passages 24A becomes excessive by setting the cross-sectional area of the through-hole 32 to be small, such gas flow would prevent flow of oil in the communication passages 24A, failing to return oil from the cylinder head 17A into the crankcase 12 appropriately.

The above disadvantage would be avoided by making the cross-sectional areas of the communication passages 24A greater. However, space available for forming the communication passages 24A and 24B in each bank VA, VB of the engine 10 is limited. Thus, to make the cross-sectional area of the communication passages 24A great is practically difficult.

On the other hand, according to the inventor's various experiments, it was confirmed that, in the engine 10 according to the present embodiment, the concentration of blow-by gas in the engine cannot be kept below the desired value when the cross-sectional area of the through-hole 32 is greater than one-second (½) of the sum of cross-sectional areas of the communication passages 24A formed in the first bank VA of the engine 10. The desired value of the concentration refers to the value at which degrading velocity of oil can be kept below a predetermined desired value of velocity and the value at which the amount of hydrocarbon (HC) leaked out of the engine 10 per unit time can be kept below a predetermined amount.

FIG. 8 illustrates the relationship between a ratio Rs (=Sh/Sr) of the cross-sectional area Sh of the through-hole 32 to the sum Sr of cross-sectional areas of the communication passages 24A, and concentration of blow-by gas in the engine 10. In FIG. 8, the line L1 represents a relationship between the concentration of blow-by gas in the crankcase 12 and the ratio Rs, and the line L2 represents a relationship between the concentration of blow-by gas at the merged portion of the chain cover 23 and the cylinder head 17A, and the ratio Rs.

As illustrated in the line L1 of FIG. 8, in the engine 10, the concentration of blow-by gas in the crankcase 12 basically becomes lower as the ratio Rs is smaller. In particular, in the area where the ratio Rs is greater than 1, the concentration of blow-by gas is decreased less even if the ratio Rs is set smaller. In the area where the ratio Rs is smaller than or equal to 1, the concentration of blow-by gas in the crankcase 12 is effectively decreased by setting the ratio Rs smaller. In the case where the ratio Rs is set ½ or less, the concentration of blow-by gas in the crankcase 12 becomes below the desired value as described above. The reason that the concentration of blow-by gas in the crankcase 12 becomes higher than the desired value in the area where the ratio Rs is greater than ½ is that lack of air that flows from the cylinder head 17A into the crankcase 12 prevents adequate ventilation of blow-by gas in the crankcase 12.

On the other hand, as illustrated in the line L2 of FIG. 8, the concentration of blow-by gas at the merged portion of the chain cover 23 and the cylinder head 17A becomes higher as the ratio Rs is smaller. Thus, if the ratio Rs is set excessively smaller, the concentration of blow-by gas in the chain cover 23 would be higher than the above desired value. However, in the engine 10, the concentration of the blow-by gas in the chain cover 23 does not actually increase when the ratio Rs is set small. The concentration of blow-by gas in the chain cover 23 can be kept below the above predetermined value until the ratio Rs becomes as small as ⅓.

Taken all together, in this embodiment, the cross-sectional area of the through-hole 32 is set to be from ⅓ to ½ of the sum of the cross-sectional areas of the communication passages 24A formed in the first bank VA of the engine 10. This allows sufficient amount of oil to flow from the cylinder head 17A down to the crankcase 12 through the communication passages 24A as well as sufficient amount of air to flow from the cylinder head 17A to the crankcase 12 and the chain cover 23 through the communication passages 24A.

The present embodiment as described above has the following advantages.

(1) The partition wall 31 and the through-hole 32 are provided in the bypass passageway including the interiors of the cylinder heads 17A and 17B, the interior of the chain cover 23, the fresh air introduction passage 27, and the breather passage 29. Accordingly, an appropriate amount of gas can be sent in the interior of the crankcase 12 and the interior of the chain cover 23, so that blow-by gas in the engine is processed appropriately.

(2) In the engine 10 where the interior of the crankcase 12 and the interior of the chain cover 23 communicate with each other, the partition wall 31 and the through-hole 32 are disposed at the location in the bypass passageway which is closer to the fresh air introduction passage 27 than the communication portion of the interior of the crankcase 12 and the interior of the chain cover 23. Thus, air that was introduced from the fresh air introduction passage 27 to the interior of the cylinder head 17A can be sent to the interior of the crankcase 12 while maintaining the inflow from the cylinder head 17A to the chain cover 23 appropriately. Accordingly, inflow of air into the crankcase 12 is ensured as desired so that blow-by gas in the crankcase 12 is ventilated desirably.

(3) The partition wall 31 and the through-hole 32 are disposed in the interior of the cylinder head 17A. That is, the partition wall 31 and the through-hole 32 can be disposed while preventing degradation of lubrication performance.

(4) The cross-sectional area of the through-hole 32 is from ⅓ to ½ of the sum of the cross-sectional areas of the plurality of communication passages 24A formed in the first bank VA. Accordingly, blow-by gas in the crankcase 12 and the chain cover 23 can be ventilated sufficiently and the sufficient amount of oil that flows from the cylinder head 17A through the communication passages 24A down to the crankcase 12 is ensured.

The above embodiment may be modified as follows.

The through-hole 32 is not limited to single through-hole but a plurality of through-holes may be formed in the partition wall 31. In this configuration, the sum of the cross-sectional areas of the through-holes may be set as ⅓ to ½ of the sum of the cross-sectional areas of the communication passages 24A.

Other than the partition wall 31 provided in the cylinder head 17A, the partition wall 31 may be provided in the cylinder head cover 20 of the cylinder head 17A. The configuration of the above embodiment is applicable irrespective of the structure of the chain mechanism as long as the engine is an internal combustion engine including a chain mechanism for operatively connecting the crank shaft and the cam shaft of each bank, and a chain cover configured to cover the chain mechanism at the location outward the engine. For example, the above embodiment is applicable to the internal combustion engine in which the intake cam shaft 18 and the exhaust cam shaft 19 are connected via a gear mechanism. In alternative embodiment, the above embodiment is also applicable to the internal combustion engine in one single chain is wound around the crank shaft 13 and the intake cam shaft 18 and the exhaust cam shaft 19 of the first bank VA and another chain is wound around the crank shaft 13 and the intake cam shaft 18 and the exhaust cam shaft 19 of the second bank VB.

The position of the partition wall 31 may be varied to any position as long as the position is located between the breather passage 29 and the fresh air introduction passage 27 in the bypass passageway and between the communication portion of the communication passages 24A with the cylinder head 17A and the communication portion of communication passages 24B with the cylinder head 17B.

For example, the partition wall may be located in the position closer to the cylinder head 17A than the portion where the crankcase 12 communicates with the chain cover 23. In this configuration, an air introduced from the fresh air introduction passage 27 into the interior of the cylinder head 17A may be sent into the crankcase 12 while maintaining the inflow from the interior of the cylinder head 17A into the chain cover 23 appropriately.

The partition wall may be located in the position closer to the cylinder head 17B than the portion where the crankcase 12 communicates with the chain cover 23. Alternatively, the partition wall may be located in the position between the communication passages 24B and the interior of the chain cover 23 in the cylinder head 17B and the position between the communication portion of the breather passage 29 and the interior of the chain cover 23. In these configurations, an amount of air that flows from the interior of the chain cover 23 into the interior of the cylinder head 17B via the communication portion between the interior of the cylinder head cover 20 and the interior of the chain cover 23 may be reduced compared to the engine lacking the partition wall. This allows a large amount of air to flows from the interior of crankcase 12 into the cylinder head 17B via the communication passage 24B. Accordingly, a large amount of air may be flown into the crankcase 12 to sufficiently ventilate blow-by gas in the crankcase 12 as well as air may be also flown into the chain cover 23 to ventilate blow-by gas in the chain cover 23.

The present invention is applicable to an internal combustion engine in which each bank is provided with different number of the cylinder bores. The present invention is also applicable to an internal combustion engine in which each bank is provided with single cylinder bore.

The present invention is applicable to an internal combustion engine having cylinders of other than V-shaped arrangement including an internal combustion engine having cylinders of horizontally opposing arrangement and an internal combustion engine having cylinders of W-shaped arrangement, as long as the internal combustion engine includes two banks, the fresh air introduction passage is connected to one bank, and the breather passage is connected to the other bank.

1. An internal combustion engine provided with a blow-by gas processing apparatus comprising:
a cylinder head;
a crankcase;
a crank shaft in the crankcase;
an intake passage, wherein a throttle valve is provided in the intake passage;
two banks, wherein the two banks are a first bank and a second bank, wherein a communication passage for communicating the interior of the cylinder head and the interior of the crankcase is provided in each bank, wherein a cam shaft is provided in each bank;
a chain mechanism operatively coupling the crank shaft and each cam shaft; and
a chain cover configured to cover the chain mechanism at the location entire outward of the entire, wherein the interior of the chain cover communicates with the interior of each cylinder head;
wherein the blow-by gas processing apparatus includes
a fresh air introduction passage for communicating the interior of the cylinder head provided at the first bank and a part of the intake passage on the upstream side of the throttle valve in the flowing direction of intake air, and
a breather passage for communicating an interior of the cylinder head provided at the second bank and a part of the intake passage on the downstream side of the throttle valve in the flowing direction of intake air,
wherein the internal combustion engine includes
a partition wall, wherein the partition wall is located in a passageway including the interior of each cylinder head, the interior of the chain cover, the fresh air introduction passage, and the breather passage, wherein the partition wall partitions the breather passage and the fresh air introduction passage, wherein the partition wall partitions a communication portion of the communication passage in the cylinder head provided at the first bank and a communication portion of the communication passage in the cylinder head provided at the second bank, wherein the partition wall includes a through-hole.

2. The internal combustion engine of claim 1, wherein an interior of the crankcase and an interior of the chain cover communicate each other, and the partition wall and the through-hole are disposed closer to the fresh air introduction passage than the communication portion between the interior of the crankcase and the interior of the chain cover in the passageway.

3. The internal combustion engine of claim 2, wherein the partition wall and the through-hole are provided in the interior of the cylinder head provided at the first bank.

4. (canceled)

5. The internal combustion engine of claim 2, wherein the communication passage is a passage that allows gas communication between the interior of the cylinder head and the interior of the crankcase and that causes oil to flow from the interior of the cylinder head down to the interior of the crankcase,
wherein the cross-sectional area of the through-hole is from one-third (⅓) to one-second (½) of the cross-sectional area of the communication passage formed at the first bank.
